(19) United States
(12) Patent Application Publication
(10) Pub. No.: US 2024/0368333 A1
(43) Pub. Date: Nov. 7, 2024

(54) PRODUCTION OF PU FOAMS USING RECYCLED POLYOLS

(71) Applicant: Evonik Operations GmbH, Essen (DE)

(72) Inventors: Roland HUBEL, Essen (DE); Annegret Terheiden, Alpen (DE); Felix Mühlhaus, Essen (DE)

(73) Assignee: Evonik Operations GmbH, Essen (DE)

(21) Appl. No.: 18/575,873

(22) PCT Filed: Jun. 28, 2022
(86) PCT No.: PCT/EP2022/067704

§ 371 Date: Jan. 1, 2024

(30) Foreign Application Priority Data
Jul. 2, 2021 (EP) 21183448.6

(51) Int. Cl. C08G 18/18; C08G 18/08; C08G 18/20; C08G 18/24; C08G 18/50; C08G 101/00

(52) U.S. Cl. CPC C08G 18/1825; C08G 18/0852; C08G 18/2018; C08G 18/24; C08G 18/5096; C08G 2101/00; C08G 2110/0008; C08G 2110/0083

(57) ABSTRACT

A process for producing polyurethane foams includes reacting at least one polyol component with at least one isocyanate component in the presence of one or more catalysts that catalyse the isocyanate-polyol and/or isocyanate-water and/or isocyanate trimerization reactions, at least one foam stabilizer and optionally one or more chemical or physical blowing agents. The polyol component includes recycled polyol.

The invention is in the field of polyurethanes and relates to the production of PU foams using recycled polyols.

On account of their exceptional mechanical and physical properties, polyurethanes find use in a very wide variety of sectors. A particularly important market for a very wide variety of polyurethanes is the PU foams sector.

Polyurethanes (PU) are for the purposes of the present invention all reaction products derived from isocyanates, in particular from polyisocyanates, and appropriately isocyanate-reactive molecules, in particular polyols. They include inter alia polyisocyanurates, polyureas and isocyanate or polyisocyanate reaction products containing allophanates, biurets, uretdiones, uretonimines or carbodiimides.

Polyurethanes are now so widespread worldwide that recycling is becoming increasingly important for these materials too. According to the state of the art, there accordingly already exists various recycling processes for the recovery of polyurethane waste. The known chemical recycling processes, such as the hydrolysis described for example in U.S. Pat. No. 5,208,379, glycolysis, acidolysis, aminolysis, hydrogenolysis, solvolysis and similar processes are aimed at depolymerization on a molecular level and in each case lead to polyol mixtures that can also sometimes be reused for PU production. These polyol mixtures are referred to very generally as recycled polyols.

The basic aim is to reuse the recycled polyols for the production of polyurethanes. Against this background, it was the specific object of the present invention to make it possible to provide PU foams using recycled polyols without there being a deterioration in the quality of the resulting foams by comparison with PU foams produced using conventional polyols, including in particular when relatively large amounts of recycled polyols are used.

The above object is achieved by the subject matter of the invention. The invention provides a process for producing PU foams by reacting
(a) at least one polyol component,
(b) at least one isocyanate component,
in the presence of
(c) one or more catalysts that catalyse the isocyanate-polyol and/or isocyanate-water and/or isocyanate trimerization reactions,
(d) at least one foam stabilizer and also
(e) optionally one or more chemical or physical blowing agents,
wherein the polyol component comprises recycled polyol.

The subject matter of the invention makes it possible, even when using relatively large amounts of recycled polyol, to provide polyurethane foams that essentially correspond to the quality of conventional polyurethane foams produced in the same way but using conventional polyols.

It therefore corresponds to a preferred embodiment of the invention when the process of the invention uses, based on the total employed polyol component, more than 30% by weight, preferably more than 50% by weight, preferably more than 70% by weight, further preferably more than 80% by weight, in particular more than 95% by weight, of recycled polyol.

Through the high proportion of recycled polyol that can be achieved, the subject matter of the invention enables a significant increase in the total proportion of recycled raw materials in the polyurethane foams generated according to the invention, which is an important advance in respect of the recyclability of polyurethane foams.

The employed recycled polyol is a polyol originating in particular from the recycling of polyurethane waste. Polyurethane waste includes any polyurethanes, in particular PU foams, that are no longer being used but are earmarked for disposal. It therefore corresponds to a preferred embodiment of the invention when the employed recycled polyol is a recycled polyol and/or recycled polymer polyol produced from polyurethane waste, preferably obtained from the depolymerization of PU foam, in particular of hot-cure flexible PU foam (standard PU foam), viscoelastic PU foam and/or HR PU foam, the recycled polyol and/or recycled polymer polyol having been obtained by solvolysis, preferably by hydrolysis, aminolysis, acidolysis or glycolysis, in particular by hydrolysis, as described for example in the as yet unpublished European patent applications under file references 20192354.7 or 20192364.6. The term “recycled polyol” encompasses for the purposes of the present invention also “recycled polymer polyol”. Following the depolymerization process, the recycled polyol may, through classical separation methods, advantageously be freed of other recycled products, in particular of the primary aromatic amines that can likewise be formed and of the added reagents for the particular depolymerization process. Some examples of methods for the purification and recovery of the recycled polyol from the crude mixture of recycling products present after the respective depolymerization step are mentioned below. One option for removing water from the crude mixture of recycling products consists of its removal by distillation. Primary aromatic amines such as tolylene 2,4-diamine, tolylene 2,6-diamine or isomers of methylenediphenyldiamine can be removed from the respective recycled polyol by distillation, by extraction with aromatic solvents or by washing with acidic wash aqueous solutions or by other methods from the crude mixture of recycling products. Any solid components that occur, such as recycling catalysts, salts or residual polyurethane components, can be removed from the crude product mixture/removed from the recycled polyols by filtration using various filter types.

The employed recycled polyol may in particular be obtained from a polyurethane hydrolysis comprising the reaction of the polyurethane with water in the presence of a base-catalyst combination (1) or (II),
where (1) comprises a base having a pK_{b} at 25° C. of 1 to 10 and a catalyst selected from the group consisting of quaternary ammonium salts containing an ammonium cation comprising 6 to 30 carbon atoms and organic sulfonates containing at least 7 carbon atoms,
or where (II) comprises a base having a pK_{b} at 25° C. of <1 and a catalyst from the group of quaternary ammonium salts containing an ammonium cation having 6 to 14 carbon atoms in the case of an ammonium cation that does not contain a benzyl substituent, or else containing an ammonium cation having 6 to 12 carbon atoms in the case of an ammonium cation that contains a benzyl substituent. The use of such recycled polyols corresponds to a preferred embodiment of the invention.

A particularly preferred variant, referred to here as preferred variant 1, of depolymerization by hydrolysis is described below.

In particular, it is preferable when the depolymerization of the polyurethane is effected using a base having a pK_{b} at 25° C. of 1 to 10, preferably 1 to 8, further preferably 1 to 7, in particular 1.5 to 6, and also a catalyst selected from the group consisting of (i) quaternary ammonium salts containing an ammonium cation comprising 6 to 30 carbon atoms and (ii) organic sulfonate containing at least 7 carbon atoms. The use of recycled polyol obtained from the described hydrolysis process corresponds to a particularly preferred embodiment of the invention.

Preferred bases comprise an alkali metal cation and/or an ammonium cation. Preferred bases are here alkali metal phosphates, alkali metal hydrogen phosphates, alkali metal carbonates, alkali metal silicates, alkali metal hydrogen carbonates, alkali metal acetates, alkali metal sulfites, ammonium hydroxides or mixtures of the above. Preferred alkali metals are Na, K or Li or mixtures of the above, in particular Na or K or mixtures thereof; preferred ammonium cation is NH₄⁺.

Particularly preferred bases are K₂CO₃, Na₂SiO₃, NH₄OH, K₃PO₄, or KOAc.

The base is preferably used in the form of a saturated alkaline solution in water, wherein the ratio by weight of saturated alkaline solution to PU is within a range preferably from 0.5 to 25, preferably 0.5 to 15, further preferably 1 to 10, in particular 2 to 7.

Preferred quaternary ammonium salts have the general structure: R₁R₂R₃R₄NX
with R₁, R₂, R₃ and R₄ identical or different hydrocarbon groups selected from alkyl, aryl and/or arylalkyl, R₁ to R₄ preferably being selected such that the sum of the carbon atoms in the quaternary ammonium cation is 6 to 14, preferably 7 to 14, in particular 8 to 13.
X is selected from halide, preferably chloride and/or bromide, hydrogen sulfate, alkyl sulfate, preferably methylsulfate or ethylsulfate, carbonate, hydrogen carbonate or carboxylate, preferably acetate or hydroxide.

Very particularly preferred quaternary ammonium salts are tributylmethylammonium chloride, tetrabutylammonium hydrogen sulfate, benzyltrimethylammonium chloride, tributylmethylammonium chloride and/or trioctylmethylammonium methylsulfate.

The organic sulfonate containing at least 7 carbon atoms that is likewise employable as catalyst preferably comprises alkyl aryl sulfonates, alpha-olefin sulfonates, petroleum sulfonates and/or naphthalene sulfonates.

Preferred temperatures for the depolymerization are 80° C. to 200° C., preferably 90° C. to 180° C., further preferably 95° C. to 170° C. and in particular 100° C. to 160° C.

Preferred reaction times for the depolymerization are 1 minute to 14 h, preferably 10 minutes to 12 h, preferably 20 minutes to 11 h and in particular 30 minutes to 10 h.

Preference is given to using for the depolymerization at least 0.5% by weight of catalyst based on the weight of the polyurethane, preferably 0.5% to 15% by weight, further preferably 1% to 10% by weight, even further preferably 1% to 8% by weight, further preferably still 1% to 7% by weight and in particular 2% to 6% by weight.

A preferred weight ratio of base to polyurethane is within a range from 0.01 to 50, preferably 0.1 to 25, in particular 0.5 to 20.

This related to the preferred variant 1 of the depolymerization.

Another further particularly preferred variant, referred to here as preferred variant 2, of depolymerization by hydrolysis is described below.

When the depolymerization of the polyurethane is effected using a base having a pK_{b} at 25° C. of <1, in particular 0.5 to −2, preferably 0.25 to −1.5, in particular 0 to −1, of a catalyst from the group of quaternary ammonium salts containing an ammonium cation having 6 to 14 carbon atoms in the case of an ammonium cation that does not contain a benzyl substituent, or else containing an ammonium cation having 6 to 12 carbon atoms in the case of an ammonium cation that contains a benzyl substituent, this is a further preferred embodiment of the invention.

Preferred bases are here alkali metal hydroxides, alkali metal oxides, alkaline earth metal hydroxides, alkali metal oxides or mixtures thereof. Preferred alkali metals are Na, K or Li or mixtures of the above, in particular Na or K or mixtures thereof, preferred alkaline earth metals are Be, Mg, Ca, Sr or Ba or mixtures thereof, preferably Mg or Ca or mixtures thereof. A very particularly preferred base is NaOH.

Preferred quaternary ammonium salts have the general structure: R₁R₂R₃R₄NX
with R₁, R₂, R₃ and R₄ identical or different hydrocarbon groups selected from alkyl, aryl and arylalkyl.
X is selected from halide, preferably chloride and/or bromide, hydrogen sulfate, alkyl sulfate, preferably methylsulfate or ethylsulfate, carbonate, hydrogen carbonate, carboxylate, preferably acetate or hydroxide.

Particularly preferred quaternary ammonium salts are here benzyltrimethylammonium chloride or tributylmethylammonium chloride.

Preferred temperatures for the depolymenzation are 80° C. to 200° C., preferably 90° C. to 180° C., further preferably 95° C. to 170° C. and in particular 100° C. to 160° C.

Preferred reaction times for the depolymerization are 1 minute to 14 h, preferably 10 minutes to 12 h, preferably 20 minutes to 11 h and in particular 30 minutes to 10 h.

Preference is given to using for the depolymerization at least 0.5% by weight of catalyst based on the weight of the polyurethane, preferably 0.5% to 15% by weight, further preferably 1% to 10% by weight, even further preferably 1% to 8% by weight, further preferably still 1% to 7% by weight and in particular 2% to 6% by weight.

A preferred weight ratio of base to polyurethane is within a range from 0.01 to 25, preferably 0.1 to 15, preferably 0.2 to 10, in particular 0.5 to 5.

Preference is given to using an alkaline solution comprising base and water, wherein the base concentration is preferably greater than 5% by weight, preferably 5% to 70% by weight, preferably 5% to 60% by weight, further preferably 10% to 50% by weight, even further preferably 15% to 40% by weight, in particular 20% to 40% by weight, based on the weight of the alkaline solution.

This related to the preferred variant 2 of the depolymerization.

The PU to be utilized in the PU depolymerization process can be any PU product, in particular it comprises a polyurethane foam, preferably rigid PU foam, flexible PU foam, hot-cure flexible PU foam (standard foam), viscoelastic PU foam, HR PU foam, hypersoft PU foam, semirigid PU foam, thermoformable PU foam and/or integral PU foam.

Recycled polyols that are for the purposes of the invention preferred preferably have a functionality (isocyanate-reactive groups per molecule) of 2 to 8. The average molecular weight of the recycled polyol is preferably within a range from 500 to 15 000 g/mol. The OH value of the recycled polyol is preferably 10 to 1200 mg KOH/g. The OH value can in particular be determined in accordance with DIN 53240:1971-12.

A preferred embodiment of the invention is when the employed recycled polyol is structurally a polyether polyol, it being possible to obtain such a recycled polyol preferably from the recycling of PU wastes, particularly PU foams, that had been obtained originally from conventional polyether polyols or from polyether polyols that had already been recycled one or more times.

In their original form prior to any recycling, polyether polyols may be produced by known processes, for example by anionic polymerization of alkylene oxides in the presence of alkali metal hydroxides, alkali metal alkoxides or amines as catalysts and with addition of at least one starter molecule, preferably containing 2 to 8 reactive hydrogen atoms in bonded form, or by cationic polymerization of alkylene oxides in the presence of Lewis acids, for example antimony pentachloride or boron trifluoride etherate, or by polymerization of alkylene oxides over double metal cyanide catalysis. Suitable alkylene oxides contain 2 to 4 carbon atoms in the alkylene radical. Examples are tetrahydrofuran, ethylene oxide, 1,3-propylene oxide, 1,2-propylene oxide and 1,2- or 2,3-butylene oxide; preference is given to using ethylene oxide and 1,2-propylene oxide. The alkylene oxides may be used individually, cumulatively, in blocks, in alteration or as mixtures. Starter molecules used are preferably di-, tri- or tetrahydric alcohols, such as ethylene glycol, propane-1,2- and -1,3-diol, diethylene glycol, dipropylene glycol, glycerol, trimethylolpropane, pentaerythrtol, castor oil, higher polyfunctional polyols, in particular sugar compounds, for example glucose, sorbitol, mannitol and sucrose, polyhydric phenols, resols.

In a preferred embodiment of the invention, especially in the production of hot-cure flexible foams, it is possible to use di- or trifunctional polyether polyols in which the proportion of end groups formed through propoxylation (PO end groups) is preferably over 50%, more preferably over 80%, in particular those having a propylene oxide block or random propylene oxide and ethylene oxide block at the chain end, or those based solely on propylene oxide blocks. Such polyether polyols preferably have a functionality from 2 to 8, more preferably from 2 to 4, number-average molecular weights within a range from 500 to 8000, preferably 800 to 5000, more preferably 2500 to 4500 g/mol, and usually OH values within a range from 10 to 100, preferably 20 to 60, mg KOH/g.

According to a preferred embodiment of the invention, especially for production of moulded and highly resilient flexible PU foams, it is possible to use di- and/or trifunctional polyether polyols having preferably at least 50%, further preferably at least 80%, primary hydroxyl groups. Especially polyether polyols having an ethylene oxide end block —CH₂—CH₂—O—H may be used. Polyols for cold-cure polyurethane foams (known as HR polyols) can come under this category when the number-average molar mass is at the same time preferably over 4000 g/mol.

In a further preferred embodiment of the invention, it is possible to use for production of hypersoft PU foams optionally also further polyether polyols consisting largely of ethylene oxide, preferably ones containing more than 70% of ethylene oxide blocks, further preferably more than 90% of ethylene oxide blocks (hypersoft polyols). All polyether polyols described in the context of this preferred embodiment preferably have a functionality of 2 to 8 hydroxy groups, preferably 2 to 5 hydroxy groups, per molecule, preferably a number-average molecular weight of 500 to 8000 g/mol, preferably 800 to 7000 g/mol, and preferably OH values within a range from 5 to 100 mg KOH/g, preferably 20 to 60 mg KOH/g. Polyols having primary hydroxyl functions are in the case of hot-cure flexible foams preferably used not on their own, but preferably together with polyols having secondary hydroxyl groups.

In a further preferred embodiment of the invention, especially for the production of viscoelastic polyurethane foams, preference is given to using mixtures of different, preferably two to three, polyfunctional polyether polyols. The polyol combinations used consist preferably of a crosslinker polyol having a high functionality (>3) and having a low molecular weight, preferably having an OH value of 100 to 400 mg KOH/g, and/or a conventional flexible slabstock foam polyol and/or a HR polyol and/or a “hypersoft” polyether polyol, preferably having an OH value of between 20 to 40 mg KOH/g, having a high proportion of ethylene oxide and cell-opening properties. When HR polyols are used within a viscoelastic foam formulation, the proportion thereof in the polyol mixture is preferably always less than 50%.

Independently of the recycled polyol of the invention, it is in the context of the present invention additionally possible to also optionally use other polyols, in particular conventional polyols. Conventional polyols are polyols that do not originate from a recycling process.

The process of the invention makes it possible to provide all known PU foam types. In a preferred embodiment of the invention, the PU foam is a rigid PU foam, a flexible PU foam, a hot-cure flexible PU foam (standard foam), a viscoelastic PU foam, an HR PU foam, a hypersoft PU foam, a semirigid PU foam, a thermoformable PU foam or an integral PU foam, preferably a hot-cure flexible PU foam, HR PU foam, hypersoft PU foam or viscoelastic PU foam. Hot-cure flexible PU foam is most preferred.

The production of the PU foams may in principle be carried out in the customary manner and as described in the prior art. It is well known to those skilled in the art. A comprehensive overview is found in, for example, G. Oertel, Polyurethane Handbook, 2nd edition, Hanser/Gardner Publications Inc, Cincinnati, Ohio, 1994, pp. 177-247. Further details of the starting materials, catalysts and auxiliaries and additives that may be used can be found for example in Kunststoffhandbuch [Plastics Handbook], volume 7, Polyurethane [Polyurethanes], Carl-Hanser-Verlag Munich, 1st edition 1966, 2nd edition 1983 and 3rd edition 1993.

When the production of the PU foams of the invention or the process of the invention is carried out using
f) water,
g) one or more organic solvents,
h) one or more stabilizers against oxidative degradation, in particular antioxidants,
i) one or more flame retardants, and/or
j) one or more further additives, preferably selected from the group of surfactants, biocides, dyes, pigments, fillers, antistatic additives, crosslinkers, chain extenders, cell openers, fragrances, cell expanders, plasticizers, hardening promoters, aldehyde scavengers, additives for resistance of PU foams to hydrolysis, compatibilizers (emulsifiers), adhesion promoters, hydrophobization additives, flame-lamination additives, additives for preventing cold flow, additives that reduce compression set, additives for adjusting the glass transition temperature, temperature-controlling additives and/or odour-reducers, this is a further preferred embodiment of the invention.

The present invention further provides a composition suitable for production of polyurethane foam, comprising at least one polyol component, at least one isocyanate component, catalyst, foam stabilizer, blowing agent, optionally auxiliaries, wherein the polyol component comprises recycled polyol. Preferred optional auxiliaries comprise surfactants, biocides, dyes, pigments, fillers, antistatic additives, crosslinkers, chain extenders, cell openers, as described for example in EP 2998333A1, fragrances, cell expanders, as described for example in EP 2986661B1, plasticizers, hardening promoters, additives for preventing cold flow, as described for example in DE 2507161C3 or WO 2017029054A1, aldehyde scavengers, as described for example in WO 2021/013607A1, additives for resistance of PU foams to hydrolysis, as described for example in US 2015/0148438A1, compatibilizers (emulsifiers), adhesion promoters, hydrophobization additives, flame-lamination additives, as described for example in EP 2292677A1, additives that reduce compression set, additives for adjusting the glass transition temperature, temperature-controlling additives and/or odour-reducers.

According to a preferred embodiment of the invention, the composition of the invention has the feature that, based on the total polyol component, more than 30% by weight, preferably more than 50% by weight, preferably more than 70% by weight, further preferably more than 80% by weight, in particular more than 95% by weight, of recycled polyol is present.

The compounds employed according to the invention, the production thereof, the use of the compounds for producing the PU foams and the PU foams themselves are hereinbelow described by way of example without any intention to limit the invention to these exemplary embodiments. Where ranges, general formulas or compound classes are specified below, these are intended to include not only the corresponding ranges or groups of compounds that are explicitly mentioned but also all subranges and subgroups of compounds that can be obtained by removing individual values (ranges) or compounds. Where documents are cited in the context of the present description, their content shall fully form part of the disclosure content of the present invention, particularly in respect of the matters referred to. Where figures are hereinbelow stated in percent, these are percentages by weight unless otherwise stated. Average values specified hereinbelow are number averages unless otherwise stated. Where properties of a material are referred to hereinbelow, for example viscosities or the like, these are the properties of the material at 25° C. unless otherwise stated. Where chemical (empirical) formulas are used in the present invention, the stated indices may be not only absolute numbers but also average values. For polymeric compounds, the indices preferably represent average values.

The process of the invention enables access to all PU foams. Preferred PU foams are for the purposes of the present invention flexible PU foams and rigid PU foams. Flexible PU foams and rigid PU foams are fixed technical terms. The known and fundamental difference between flexible foams and rigid foams is that flexible foam shows elastic behaviour and hence deformation is reversible. By contrast, rigid foam undergoes permanent deformation. Various foam subgroups that are in the context of the invention preferred are described in more detail hereinbelow.

In the context of the present invention, rigid polyurethane foam is in particular understood as meaning a foam to DIN 7726:1982-05 that has a compressive strength to DIN 53421:1984-06 of advantageously ≥20 kPa, preferably ≥80 kPa, more preferably ≥100 kPa, further preferably ≥150 kPa, particularly preferably ≥180 kPa. In addition, the rigid polyurethane foam to DIN EN ISO 4590:2016-12 advantageously has a closed-cell content of greater than 50%, preferably greater than 80% and more preferably greater than 90%. Rigid PU foams are used mostly for insulation purposes.

Flexible PU foams are elastic, reversibly deformable and preferably usually have open cells. This means that the air can escape easily on compression. The umbrella term “flexible PU foam” here includes in particular the following foam types known to those skilled in the art, namely hot-cure flexible PU foam (standard PU foam), cold-cure PU foam, (also highly elastic or high resilient foam), hypersoft PU foam, viscoelastic flexible PU foam and ester-type PU foams (from polyester polyols). The different flexible PU foam types are explained in more detail again and differentiated from one another hereinbelow.

The crucial difference between a hot-cure flexible PU foam and a cold-cure PU foam lies in the different mechanical properties. The distinction between hot-cure flexible PU foams and cold-cure flexible PU foams can be made in particular through the rebound resilience, also known as “ball rebound” (BR) or “resilience”. A method for determining the rebound resilience is described for example in DIN EN ISO 8307:2008-03. In this method, a steel ball having a fixed mass is allowed to fall from a defined height onto the test specimen and the height of the rebound as a % of the drop height is then measured. Hot-cure flexible PU foams have rebound values of preferably 1% to not more than 50%. The height of the rebound in the case of cold-cure flexible PU foams is preferably within the range >50%. The high rebound resilience of cold-cure flexible PU foams results from a relatively irregular cell size distribution. A further mechanical criterion is the sag or comfort factor. Here, a foam specimen is compressed to DIN EN ISO 2439.2009-05 and the ratio of compressive stress at 65% and 25% compression is measured. Hot-cure flexible PU foams have a comfort factor of preferably <2.5. In the case of cold-cure flexible PU foams, the comfort factor is preferably >2.5. The production of cold-cure flexible PU foams preferably employs polyether polyols that are highly reactive towards isocyanates and have a high proportion of primary hydroxyl groups and number-average molar masses >4000 g/mol. In the case of hot-cure flexible PU foams, on the other hand, less reactive polyols having secondary OH groups and an average molar mass of <4000 g/mol are preferably predominantly used. As well as cold-cure slabstock PU foams, moulded cold-cure PU foams, which are used for example in automotive seat cushioning, represent a core use of cold-cure PU foams.

Preference is according to the invention likewise given to hypersoft PU foams, which represent a subcategory of flexible PU foams. Hypersoft PU foams have compressive stresses determined to DIN EN ISO 3386-1:1997+A1:2010 of preferably <2.0 kPa and exhibit indentation hardnesses determined to DIN EN ISO 2439:2009-05 of preferably <80 N. Hypersoft PU foams can be produced by various known processes: through use of a so-called hypersoft polyol in combination with so-called standard polyols and/or through a special production process in which carbon dioxide is metered in during the foaming process. A pronounced open-cell structure of hypersoft PU foams gives them high air permeability, promotes moisture transfer in application products and helps avoid heat buildup. A particular feature of the hypersoft polyols employed for production of hypersoft PU foams is a very high proportion of primary OH groups of more than 60%.

A special class of flexible PU foams is that of viscoelastic PU foams (visco foams), which are likewise preferred according to the invention. These are also known as “memory foam” and are notable both for a low rebound resilience to DIN EN ISO 8307:2008-03 of preferably <15% and for a slow, gradual recovery after compression (recovery time preferably 2-13 s). In contrast to hot-cure flexible PU foams and cold-cure flexible PU foams, which have a glass transition temperature of preferably less than −32° C., for viscoelastic PU foams the glass transition temperature is preferably shifted to within a range from −20 to +15° C. Such “structural viscoelasticity” in the case of open-cell viscoelastic PU foams, which is based essentially on the glass transition temperature of the polymer (also referred to as chemical visco foams), should be distinguished from a pneumatic effect. In the latter case, there is a relatively closed cell structure (low porosity). The low air permeability means that the air flows back in only gradually after compression, which results in slowed recovery (also referred to as pneumatic visco foams). In many cases the two effects are combined in a visco foam. PU visco foams are highly prized on account of their energy- and sound-absorbing properties.

A class of PU foams that is particularly important for applications in the automotive sector and has properties in between those of rigid and flexible foams is that of semirigid PU foams (also semiflexible PU foams). These too are preferred according to the invention. Like most PU foam systems, semirigid foam systems also make use of the diisocyanate/water reaction and of the CO₂ evolved as a blowing agent for foam formation. The rebound resilience is generally lower than that of classical flexible foams, especially cold-cure foams. Semirigid foams have higher hardness than conventional flexible foams. A characteristic feature of semirigid foams is their high open-cell content (preferably >90% of cells). The densities of semirigid foams can be significantly greater than those of flexible and rigid foams.

The polyol components employed are preferably one or more polyols having two or more OH groups, wherein it is obligatory for the polyol component according to the invention to comprise recycled polyol. It is in addition optionally possible for further polyols also to be used.

Preferred further polyols that are optionally additionally employable are all polyether polyols and polyester polyols normally used for production of polyurethane systems, in particular polyurethane foam systems.

Polyether polyols are obtainable for example by reacting polyfunctional alcohols or amines with alkylene oxides. Polyester polyols are based preferably on esters of polybasic carboxylic acids with polyhydric alcohols (usually glycols). The polybasic carboxylic acids can either be aliphatic (for example adipic acid) or aromatic (for example phthalic acid or terephthalic acid).

An important class of optionally employable polyols obtainable from natural oils such as palm oil or soybean oil are known as “natural oil-based polyols” (NOPs) and can be obtained on the basis of renewable raw materials. NOPs are of increasing interest for more sustainable production of PU foams in view of the long-term limits on the availability of fossil resources—oil, coal and gas—and against the background of rising crude oil prices and have already been described many times in the production of polyurethane foams (WO 2005/033167; US 2006/0293400, WO 2006/094227, WO 2004/096882, US 2002/0103091, WO 2006/116456 and EP 1678232) A number of these polyols are now commercially available from various manufacturers (WO 2004/020497, US 2006/0229375, WO 2009/058367). Depending on the base raw material (e.g. soybean oil, palm oil or castor oil) and subsequent processing, polyols having a varying property profile are obtained. It is possible here to distinguish essentially between two groups: a) polyols based on renewable raw materials that are modified such that they can be used to an extent of 100% for production of polyurethanes (WO 2004/020497, US 2006/0229375); b) polyols based on renewable raw materials that, because of the processing and properties thereof, are able to replace the petrochemical-based polyol only up to a certain proportion (WO 2009/058367). The production of polyurethane foams from recycled polyols together with NOPs represents a preferred type of application of the invention.

A further class of optionally employable polyols comprises polyols obtained as prepolymers by reaction of polyol with isocyanate in a molar ratio of 100:1 to 5:1, preferably 50:1 to 10:1.

Yet another class of optionally employable polyols comprises what are known as filled polyols (polymer polyols). These contain dispersed solid organic fillers up to a solids content of 40% by weight or more. Employable polyols include for example inter alia:

SAN polyols: These are highly reactive polyols containing a dispersed copolymer based on styrene-acrylonitrile (SAN).

PUD polyols: These are highly reactive polyols also containing polyurea particles in dispersed form.

PIPA polyols: These are highly reactive polyols containing polyurethane particles in dispersed form, produced for example by in-situ reaction of an isocyanate with an alkanolamine in a conventional polyol.

The solids content in the optional filled polyols, which depending on the application may preferably be between 5% and >40% by weight based on the polyol, is responsible for improved cell opening, with the result that the polyol becomes controllably foamable, especially with TDI, and no shrinkage of the foams occurs. The solids content thus acts as an essential processing aid. A further function is to control the hardness via the solids content, since higher solids contents result in a higher hardness of the foam.

Formulations comprising polyols that contain solids have markedly reduced inherent stability and therefore tend to require not only chemical stabilization through the crosslinking reaction but also additional physical stabilization.

Other optionally employable polyols are those known as cell-opener polyols. These are polyether polyols having a high ethylene oxide content, specifically a content preferably of at least 40% by weight, in particular of 50% to 100% by weight, based on the content of alkylene oxide.

A ratio of isocyanate component to polyol component that is preferred in the context of the present invention, and is expressed as an index, is within a range from 10 to 1000, preferably 40 to 350. This index describes the ratio of the amount of isocyanate actually used to the amount of isocyanate theoretically required for a stoichiometric ratio of isocyanate groups to isocyanate-reactive groups (e.g. OH groups, NH groups), multiplied by 100. An index of 100 represents a molar ratio of reactive groups of 1:1.

The isocyanate components used are preferably one or more isocyanates having two or more isocyanate functions. Any isocyanate may be used as isocyanate component in the process of the invention, in particular the aliphatic, cycloaliphatic, araliphatic and preferably aromatic polyfunctional isocyanates known per se. Suitable isocyanates for the purposes of the present invention have two or more isocyanate functions.

Suitable isocyanates for the purposes of the present invention are preferably any polyfunctional organic isocyanates, for example diphenylmethane diisocyanate (MDI), toluene diisocyanate (TDI), hexamethylene diisocyanate (HMDI) and/or isophorone diisocyanate (IPDI). Preference is likewise given to using the mixture known as “polymeric MDI” (“crude MDI” or polyphenyl polymethylene polyisocyanate), composed of MDI and analogues with a higher level of condensation having an average functionality of 2 to 4.

Particular preference is given to using diphenylmethane 2,4′-diisocyanate and/or diphenylmethane 2,2′-diisocyanate and/or polyphenyl polymethylene polyisocyanate (crude MDI) and/or toluene 2,4-diisocyanate and/or toluene 2,6-diisocyanate or mixtures thereof.

MDI prepolymers are preferably also particularly suitable. Examples of particularly suitable isocyanates are detailed for example in EP 1712578, EP 1161474, WO 00/58383, US 2007/0072951, EP 1678232 and WO 2005/085310, which are hereby fully incorporated by reference.

It corresponds to a preferred embodiment of the invention when the isocyanate used, preferably diphenylmethane diisocyanate (MDI) and toluene diisocyanate (TDI), consists preferably to an extent of at least 20%, further preferably to an extent of at least 40%, particularly preferably to an extent of at least 60%, of recycled isocyanates.

In a preferred embodiment of the invention, the recycled isocyanates are produced from the reaction of aromatic amine mixtures consisting of toluene diisocyanate (TDI) and/or methylenediphenylamine (MDA), the amine mixtures having been obtained preferably to an extent of at least 20%, further preferably to an extent of at least 35%, particularly preferably to an extent of at least 50%, from the recycling of polyurethanes, preferably polyurethane foams.

Suitable catalysts for possible use in the process of the invention for producing PU foams are preferably substances that catalyse the gel reaction (isocyanate-polyol), the blowing reaction (isocyanate-water) or the di- or trimerization of the isocyanate.

It corresponds to a preferred embodiment of the invention when the catalyst used is selected from triethylenediamine, 1,4-diazabicyclo[2.2.2]octane-2-methanol, diethanolamine, N-[2-[2-(dimethylamino)ethoxy]ethyl]-N-methyl-1,3-propanediamine, 2-[[2-(2-(dimethylamino)ethoxy)ethyl]methylamino]ethanol, 1,1′-[(3-{bis[3-(dimethylamino)propyl]amino}propyl)imino]dipropan-2-ol, [3-(dimethylamino)propyl]urea, 1,3-bis[3-(dimethylamino)propyl]urea and/or amine catalysts of general structure (1a) and/or of structure (1b):

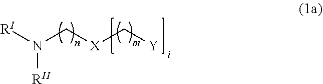

X comprises oxygen, nitrogen, hydroxyl, amino groups of the structure NR^{III} or NR^{III}R^{IV} or urea groups (N(R^{V})C(O)N(R^{VI}) or N(R^{VII})C(O)NR^{VI}R^{VII}),
Y comprises amino groups NR^{VII}R^{IX} or alkoxy groups OR^{IX},
R^{I,II} comprise identical or different, linear or cyclic, aliphatic or aromatic hydrocarbon groups having 1-8 carbon atoms that are optionally functionalized with an OH group and/or comprise hydrogen,
R^{III-IX} comprise identical or different, linear or cyclic, aliphatic or aromatic hydrocarbon groups having 1-8 carbon atoms that are optionally functionalized with an OH group, an NH or NH₂ group and/or comprise hydrogen,
m=0 to 4, preferably 2 or 3,
n=2 to 6, preferably 2 or 3,
i=0 to 3, preferably 0 to 2,

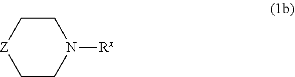

R^{X} comprises identical or different radicals consisting of hydrogen and/or linear, branched or cyclic, aliphatic or aromatic hydrocarbon groups having 1-18 carbon atoms, which may be substituted with 0-1 hydroxyl groups and 0-1 NH₂ groups,
Z comprises oxygen, N—R^{X} or CH₂
and/or
metal compounds including organometallic metal salts, organic metal salts, inorganic metal salts or organometallic compounds of the metals Sn, Bi, Zn, Al or K, preferably Sn or Bi, or mixtures of these. The indices used previously for formulae (1a) and (1b) relate exclusively to these structures. In other sections the same indices may optionally be used for other structures.

A class of suitable catalysts that may be used with preference in the process of the invention are metal compounds of the metals Sn, Bi, Zn, Al or K, in particular Sn, Zn or Bi. The metal compounds can be divided into the subgroups of organometallic compounds, organometallic salts, organic metal salts and inorganic metal salts, which are explained hereinbelow.

The expression “metalorganic or organometallic compounds” encompasses for the purposes of the present invention in particular the use of metal compounds having a direct carbon-metal bond, here also referred to as metal organyls (e.g. tin organyls) or organometallic/organometal compounds (e.g. organotin compounds). The expression “organometallic or metalorganic salts” encompasses for the purposes of the present invention in particular the use of metalorganic or organometallic compounds having salt character, i.e. ionic compounds in which either the anion or cation is organometallic in nature (e.g. organotin oxides, organotin chlorides or organotin carboxylates). The expression “organic metal salts” encompasses for the purposes of the present invention in particular the use of metal compounds that do not have any direct carbon-metal bond and are at the same time metal salts in which either the anion or the cation is an organic compound (e.g. tin(II) carboxylates). The expression “inorganic metal salts” encompasses for the purposes of the present invention in particular the use of metal compounds or of metal salts in which neither the anion nor the cation is an organic compound, e.g. metal chlorides (e g tin(II) chloride).

Organic and organometallic metal salts that are suitable for use contain preferably alkoxide, mercaptate or carboxylate anions, such as acetate, 2-ethylhexanoate, octoate, isononanoate, decanoate, neodecanoate, ricinoleate, laurate and/or oleate, particularly preferably 2-ethylhexanoate, ricinoleate, neodecanoate or isononanoate.

As a general rule, metal-containing catalysts that are suitable for use are preferably selected such that they do not have any troublesome intrinsic odour and are essentially toxicologically safe, and such that the resulting polyurethane systems, especially polyurethane foams, have the lowest possible degree of catalyst-related emissions.

It may be preferable to combine one or more metal compounds with one or more amine catalysts of formula (1a) and/or (1b).

In the production according to the invention of polyurethane foams, it may be preferable to exclude the use of organometallic salts, for example of dibutyltin dilaurate.

Suitable amounts in which these catalysts for the production of PU foam are used for the production of PU foam in the process of the invention depend on the type of catalyst and are preferably within a range from 0.01 to 5 pphp (=parts by weight based on 100 parts by weight of polyol) or from 0.1 to 10 pphp in the case of potassium salts.

Suitable amounts of water in the process of the invention depend on whether or not physical blowing agents are used in addition to water. In the case of purely water-blown foams, values range from preferably 1 to 20 pphp; when other blowing agents are additionally used, the amount of water used is reduced to usually e.g 0 or e.g 0.1 to 5 pphp. To achieve high foam densities, it is preferable that neither water nor any other blowing agent is used.

Physical blowing agents that are suitable for use for the purposes of the present invention are gases, for example liquefied CO₂, and volatile liquids, for example hydrocarbons having 4 or 5 carbon atoms, preferably cyclo-, iso- and n-pentane, hydrofluorocarbons, preferably HFC 245fa, HFC 134a and HFC 365mfc, but also olefinic hydrofluorocarbons such as HHO 1233zd or HHO1336mzzZ, hydrochlorofluorocarbons, preferably HCFC 141b, oxygen-containing compounds such as methyl formate and dimethoxymethane, or chlorinated hydrocarbons, preferably dichloromethane and 1,2-dichloroethane. Suitable blowing agents further include ketones (e.g. acetone) or aldehydes (e.g. methylol).

In addition to or in place of water and any physical blowing agents, the additive composition of the invention may also include other chemical blowing agents that react with isocyanates with gas evolution, examples being formic acid, carbamates or carbonates.

Foam stabilizers (referred to as stabilizers for the purposes of the invention) that can be used include the substances mentioned in the prior art. The compositions of the invention may advantageously contain one or more stabilizers.

They are in particular silicon compounds containing carbon atoms, preferably selected from polysiloxanes, polydimethylsiloxanes, organomodified polysiloxanes, polyether-modified polysiloxanes and polyether-polysiloxane copolymers.

It corresponds to a preferred embodiment of the invention when the foam stabilizer is selected from the group of silicon compounds that include carbon atoms, preferably described by the formula (1c), or mixtures of two or more of said compounds:

[R¹₂R²SiO_{1/2}]ₐ[R¹₃SiO_{1/2}]_{b}[R¹₂SiO_{1/2}]_{c}[R¹R²SiO_{2/2}]_{d}[R³SiO_{3/2}]ₑ[SiO_{4/2}]_{f}G_{g} Formula (1c):
where
   a=0 to 12, preferably 0 to 10, more preferably 0 to 8,
   b=0 to 8, preferably 0 to 6, more preferably 0 to 2,
   c=0 to 250, preferably 1 to 200, more preferably 1.5 to 150,
   d=0 to 40, preferably 0 to 30, more preferably 0 to 20,
   e=0 to 10, preferably 0 to 8, more preferably 0 to 6,
   f=0 to 5, preferably 0 to 3, more preferably 0,
   g=0 to 3, preferably 0 to 2.5, more preferably 0 to 2,
   where:

$$a + b + c + d + e + f + g > 3 , a + b \geq 2 ,$$

G=independently identical or different radicals consisting of
(O_{1/2})ₙSiR¹ₘ—CH₂CHR⁵-R⁴—CHR⁵CH₂—SiR¹ₘ(O_{1/2})ₙ,
(O_{1/2})ₙSiR¹ₘ—CH₂CHR⁵-R₄—CR⁵═CH₂,
(O_{1/2})ₙSiR¹ₘ—CH₂CHR⁵-R⁴—CR₅═CR⁵—CH₃,
R₄=independently identical or different divalent organic radicals, preferably divalent organic radicals of 1 to 50 carbon atoms, optionally interrupted by ether, ester or amide groups and optionally functionalized with OH groups, or (—SiR¹₂O—)ₓSiR¹₂ groups, more preferably identical or different divalent organic radicals of 2 to 30 carbon atoms, optionally interrupted by ether, ester or amide groups and optionally functionalized with OH groups, or (—SiR¹₂O—) SiR¹₂ groups,
x=1 to 50, preferably 1 to 25, more preferably 1 to 10,
R⁵=independently identical or different alkyl radicals consisting of 1 to 16 carbon atoms, aryl radicals having 6 to 16 carbon atoms or hydrogen, preferably from the group of alkyl radicals having 1 to 6 carbon atoms or aryl radicals having 6 to 10 carbon atoms or hydrogen, more preferably methyl or hydrogen,
where:

$$n = 1 or 2 , m = 1 or 2 , n + m = 3 ,$$

R¹=identical or different radicals selected from the group of saturated or unsaturated alkyl radicals having 1 to 16 carbon atoms or aryl radicals having 6 to 16 carbon atoms or hydrogen or —OR⁶, preferably methyl, ethyl, octyl, dodecyl, phenyl or hydrogen, more preferably methyl or phenyl,
R²=independently identical or different polyethers obtainable by the polymerization of ethylene oxide and/or propylene oxide and/or other alkylene oxides such as butylene oxide or styrene oxide having the general formula (2) or an organic radical corresponding to formula (3)

—(R⁷)ₕ—O—[C₂H₄O]ⱼ—[C₃H₄O]ᵢ—[CR⁸₂CR⁸₂O]ₖ—R⁹, (2)

—Oₕ—R¹⁰, (3)
where

$$h = 0 or 1 ,$$

R⁷=divalent organic radical, preferably divalent organic alkyl or aryl radical optionally substituted with —OR⁶, more preferably a divalent organic radical of type CₚH₂ₚ,
i=0 to 150, preferably 1 to 100, more preferably 1 to 80,
j=0 to 150, preferably 0 to 100, more preferably 0 to 80,
k=0 to 80, preferably 0 to 40, more preferably 0,
p=1-18, preferably 1-10, more preferably 3 or 4,
where
i+j+k≥3,
R³=identical or different radicals selected from the group of saturated or unsaturated alkyl radicals potentially substituted with heteroatoms, preferably identical or different radicals selected from the group of saturated or unsaturated alkyl radicals having 1 to 16 carbon atoms or aryl radicals having 6-16 carbon atoms potentially substituted with halogen atoms, more preferably methyl, vinyl, chloropropyl or phenyl,
R⁶=identical or different radicals selected from the group of saturated or unsaturated alkyl radicals having 1 to 16 carbon atoms or aryl radicals having 6 to 16 carbon atoms or hydrogen, preferably saturated or unsaturated alkyl radicals having 1 to 8 carbon atoms or hydrogen, more preferably methyl, ethyl, isopropyl or hydrogen,
R⁸=identical or different radicals selected from the group of alkyl radicals having 1 to 18 carbon atoms, potentially substituted with ether functions and potentially substituted with heteroatoms such as halogen atoms, aryl radicals having 6-18 carbon atoms, potentially substituted with ether functions, or hydrogen, preferably alkyl radicals having 1 to 12 carbon atoms, potentially substituted with ether functions and potentially substituted with heteroatoms such as halogen atoms or aryl radicals having 6-12 carbon atoms, potentially substituted with ether functions, or hydrogen, more preferably methyl, ethyl, benzyl or hydrogen,
R⁹=identical or different radicals selected from the group hydrogen, alkyl, —C(O)—R¹¹, —C(O)O—R¹ or —C(O)NHR¹¹, saturated or unsaturated, optionally substituted with heteroatoms, preferably hydrogen or alkyl radicals having 1 to 8 carbon atoms or acetyl, more preferably hydrogen, acetyl, methyl or butyl,
R¹⁰=identical or different radicals selected from the group of saturated or unsaturated alkyl radicals or aryl radicals, potentially substituted with one or more OH, ether, epoxide, ester, amine and/or halogen substituents, preferably saturated or unsaturated alkyl radicals having 1 to 18 carbon atoms or aryl radicals having 6-18 carbon atoms, optionally substituted with one or more OH, ether, epoxide, ester, amine and/or halogen substituents, more preferably saturated or unsaturated alkyl radicals having 1 to 18 carbon atoms or aryl radicals having 6-18 carbon atoms substituted with at least one OH, ether, epoxide, ester, amine and/or halogen substituent,
R¹¹=identical or different radicals selected from the group of alkyl radicals having 1 to 16 carbon atoms or aryl radicals having 6 to 16 carbon atoms, preferably saturated or unsaturated alkyl radicals having 1 to 8 carbon atoms or aryl radicals having 6 to 12 carbon atoms, more preferably methyl, ethyl, butyl or phenyl.

The foam stabilizers of formula (1c) may be used preferably in organic solvents such as dipropylene glycol, polyether alcohols or polyether diols blended in PU systems.

In the case of mixtures of stabilizers of formula (1c), it is additionally preferably possible to use a compatibilizer. This compatibilizer may be selected from the group of aliphatic or aromatic hydrocarbons, more preferably aliphatic polyethers or polyesters.

The indices used previously for formula (1c) relate exclusively to this structure. In other sections the same indices may optionally be used for other structures.

Employable silicon compounds having one or more carbon atoms preferably include the substances mentioned in the prior art. Preference is given to using those silicon compounds that are particularly suitable for the particular type of foam. Suitable siloxanes are described for example in the following documents: EP 0839852, EP 1544235, DE 102004001408, WO 2005/118668, US 2007/0072951, DE 2533074, EP 1537159, EP 533202, U.S. Pat. No. 3,933,695, EP 0780414, DE 4239054, DE 4229402, EP 867465. The silicon compounds may be produced as described in the prior art. Suitable examples are described e.g. in U.S. Pat. No. 4,147,847, EP 0493836 and U.S. Pat. No. 4,855,379.

From 0.00001 to 20 parts by mass of foam stabilizers, in particular silicon compounds, per 100 parts by mass of polyol components may preferably be used.

Optional additives used may be all substances known from the prior art that are used in the production of polyurethanes, in particular of polyurethane foams, examples being blowing agents, preferably water for formation of CO₂, and, if necessary, further physical blowing agents, flame retardants, buffer substances, surfactants, biocides, dyes, pigments, fillers, antistatic additives, crosslinkers, chain extenders, cell openers, as described for example in EP 2998333A1, nucleating agents, thickeners, fragrances, cell expanders, as described for example in EP 2986661B1, plasticizers, hardening promoters/additives for preventing cold flow, as described for example in DE 2507161C3, WO 2017029054A1, aldehyde scavengers, as described for example in WO 2021/013607A1, additives for resistance of PU foams to hydrolysis, as described for example in US 2015/0148438A1, compatibilizers (emulsifiers), adhesion promoters, hydrophobization additives, flame-lamination additives, as described for example in EP 2292677B1, additives that reduce compression set, additives for adjusting the glass transition temperature, temperature-controlling additives, odour-reducers and/or additional catalytically active substances, in particular as defined above.

A few optional additives will be described in more detail below within the context of a few preferred embodiments.

According to a preferred embodiment of the invention, waxes having a melting point within a range from 40 to 80° C. and having a minimum content of 50% microcrystalline wax may in the process of the invention be employed as an additive for cell expansion in a proportion of 0.0001 to 5.0 percent based on the total sum of the polyol components.

According to a preferred embodiment of the invention, a cell opener may be employed in the process of the invention, preferably from the group of polyether-polysiloxane copolymers, the amount used preferably being from 0.01% to 10% by weight based on the total sum of the polyol components, particularly preferably 0.1% to 5% by weight based on the total sum of the polyol components. Particular preference is given to using polyether-polysiloxane copolymers of the formula (1f).

MₐM¹_{b}D_{c}D¹_{d}TₑQ_{f}G_{g} formula (1f)
where

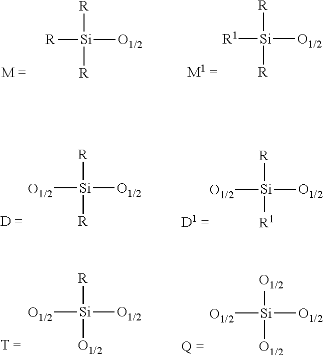

G=independently identical or different radicals from the group:

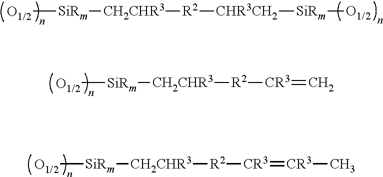

a=0-20, preferably 0-10, e.g. 1-8 or 2-8, in particular 2.4-4.1,
b=0-20, preferably 0-10, e.g. 1-8 or 2-8, in particular 0,
c=3-450, preferably 5-350, e.g. 5-300, in particular 10-250,
d=0-40, preferably 1-30, e.g. 1-20, in particular 1.5-20,
e=0-20, preferably 0-10, e.g. 1-8, in particular 0,
f=0-20, preferably 0-10, e.g. 1-8, in particular 0,
g=0.1-3, preferably 0.15-2, in particular 0.2-1.5,
wherein a+b≥2 and N=a +b+c+d+e+f+g≥11 and ≤500, b+d≥1
R=independently identical or different alkyl radicals having 1-16 carbon atoms or aryl radicals having 6-16 carbon atoms or H or —OR³, preferably methyl, ethyl, phenyl, octyl, dodecyl or H, in particular methyl,
R¹=independently identical or different polyether radicals, preferably identical or different polyether radicals of the general formula (2f)

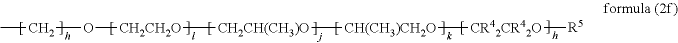

R₂=independently identical or different divalent organic radicals, preferably identical or different divalent organic radicals having 1-50, more preferably having 2-30 carbon atoms, which are optionally interrupted by ether, ester or amide functions or (—SiR₂O—)ₙ groups and optionally bear OH functions,
R³=independently identical or different alkyl radicals having 1-16 carbon atoms or aryl radicals having 6-16 carbon atoms or H,
R⁴=identical or different alkyl radicals having 1 to 18 carbon atoms, which optionally have ether functions, or aryl radicals having 6-18 carbon atoms, which optionally have ether functions, or H, preferably H, ethyl and benzyl,
R⁵=identical or different radicals from the group: R³, H, —C(O)R³, preferably methyl, butyl, H or —C(O)Me,
n=independently 1 or 2
m=independently 1 or 2

$$m + n = 3$$

h=2-18, preferably 2-10, particularly preferably 3,
i=0-100, preferably 0-80, particularly preferably 0-50, e.g. 1-40,
j=0-100, preferably 0-80, particularly preferably 0-50, e.g. 1-40,
k=0-100, preferably 0-80, particularly preferably 0-50, e.g. 1-40,
l=0-80, preferably 0-40, e g 1-30, particularly preferably 0,
with the proviso that i+j+k+l≥3.

The indices used in formulae (1f) and (2f) apply only to this section of the description of the invention. In other sections, the same indices may optionally be used for other structures.

The structures of particularly suitable cell openers from the group of polyether-polysiloxane copolymers are described in European patent application EP 2998333 A1. Preferably, the compounds of formula (1) as defined in EP 2998333 A1, and more precisely in Claim 1 therein, can be used as cell openers. The use of corresponding cell openers from the group of polyether-polysiloxane copolymers corresponds to a preferred embodiment of the invention.

According to a preferred embodiment of the invention, a hardening promoter may be employed in the process of the invention, the amount used being preferably 0.1% to 7.0% by weight, preferably 0.2% to 5.0% by weight, more preferably 0.2% to 3.0% by weight, based on the hydroxyl equivalent of the total polyol component.

When the hardening promoter comprises a solid that does not dissolve at all or dissolves only very slightly in polyether polyols at room temperature (solubility less than 0.25 g/100 g polyether polyol) from the group consisting of sorbitol, trimethylolomelamine, hexamethylolmelamine, glucose, sucrose, erythritol, pentaerythritol, mixtures or hydrates of said compounds or partial esters or ethers thereof, this is a further preferred embodiment of the invention. The hardening promoter may preferably be employed in the form of the pure substances or dispersions.

According to a preferred embodiment of the invention, an additive comprising halogen compounds may be employed in the process of the invention to improve the resistance of the PU foam to hydrolysis, the amount used being preferably 0.1% to 3.5% by weight, preferably 0.2% to 2.5% by weight, more preferably 0.3% to 2.0% by weight, based on the total sum of the polyol components.

Halogen compounds that can be used with preference have a percent by weight content of halogen of 10% to 75% by weight, preferably 10% to 60% by weight, more preferably 20% to 55% by weight. Halogen compounds that can be used with preference are linear, branched, aliphatic, cycloaliphatic or aromatic halogenated hydrocarbon compounds having at least one carbon-halogen bond and 0-10 functional groups selected from hydroxyl, ester, amide and ether groups. Particularly preferred are linear and branched, aliphatic, cycloaliphatic and aromatic halogenated hydrocarbon compounds having at least one carbon-halogen bond and 0-3 functional groups selected from hydroxyl, ester, amide and ether groups.

It corresponds to a particularly preferred embodiment of the invention when a halohydrin is used as an additive to improve the resistance of the PU foam to hydrolysis. Halohydrins contain at least one halogen function selected from Cl—, Br—, I— or F— and at least one hydroxyl function. Preference is given to using chlorine- or bromine-containing halohydrins. With further preference, 3-chloro-1-propanol, 3-bromo-1-propanol, 4-chloro-1-butanol, 4-bromo-1-butanol, 5-chloro-1-pentanol, 6-chloro-1-hexanol, 8-chloro-1-octanol, 2-(2-chloroethoxy)ethanol, 2,3-dichloropropanol, 2,2-dichloroethanol, 1-chloro-2-propanol, 3-bromo-1-propanol, ethylene chlorohydrin, or 1-chloro-2,3-propandiol, or mixtures of the above may be used.

Optionally employable crosslinkers and optionally employable chain extenders are low-molecular-weight polyfunctional compounds that are reactive toward isocyanates Examples of suitable compounds are hydroxyl- or amine-terminated substances such as glycerol, dipropylene glycol, neopentyl glycol, 2-methylpropane-1,3-diol, triethanolamine (TEOA), diethanolamine (DEOA), trimethylolpropane and/or sugar compounds. Crosslinkers which can likewise optionally be employed are polyethoxylated and/or polypropoxylated glycerol or sugar compounds, so long as their number-average molecular weight is below 1500 g/mol. The optional use concentration is preferably between 0.1 and 5 parts based on 100 parts of polyol, but can also deviate therefrom depending on the formulation. When crude MDI is used in in-situ foaming, it likewise takes on a crosslinking function. The content of low-molecular-weight crosslinkers can therefore be accordingly reduced as the amount of crude MDI increases.

Suitable optional stabilizers against oxidative degradation, known as antioxidants, preferably include all common free-radical scavengers, peroxide scavengers, UV absorbers, light stabilizers, complexing agents for metal ion impurities (metal deactivators).

It corresponds to a particularly preferred embodiment of the invention when a stabilizer against oxidative degradation, in particular antioxidants, is used, selected from
(i) 2-(2′-hydroxyphenyl)benzotriazoles, here particularly preferably 2-(2′-hydroxy-5′-methylphenyl)benzotriazole or 2-(2′-hydroxy-3′,5′-di-tert-butylphenyl)benzotriazole,
(ii) 2-hydroxybenzophenones, here particularly preferably 2-hydroxy-4-n-octoxybenzophenone, 2,2′,4,4′-tetrahydroxybenzophenone or 2,4-dihydroxybenzophenone,
(iii) benzoic acids and benzoates, here particularly preferably hexadecyl-3,5-di-tert-butyl-4-hydroxy benzoate or tannins,
(iv) phenols, preferably phenolic esters based on 3-(4-hydroxyphenyl)propionic acid, such as triethyleneglycol-bis-[3-(3-tert-butyl-4-hydroxy-5-methylphenyl)propionate], octadecyl-3-(3,5-di-tert-butyl-4-hydroxyphenyl)propionate, or methylenediphenols such as 4,4′-butylidene-bis-(6-tert-butyl-3-methylphenol, further preferred are all phenols with tert-butyl and or methyl substituents on the aromatic entity, very particularly preferred are phenolic antioxidants of the formula (1d)

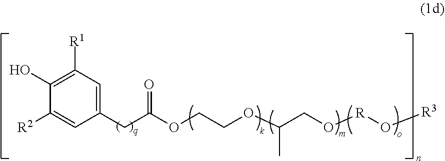

in which
R is CH₂—CH(R^{I}), CH(R^{II})—CH(R^{II}), CH₂—C(R^{II})₂, C(R^{II})₂—C(R^{II})₂, CH₂—CH—CH₂—R^{IV}, C₆H₅—CH—CH₂, C₆H₅—C(CH₃)—CH₂ or

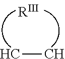

where
R^{I} is a C₂ to C₂₄ alkyl radical or alkenyl radical that may be linear or branched,
R^{II} is a C₂ to C₂₄ alkyl radical or alkenyl radical that may be linear or branched,
R^{III} is a C₃ to C₆ alkyl radical in a linear arrangement, and
R^{IV} is OH, Cl, OCH₃, OCH₂—CH₃, O—CH₂—CH═CH₂, O—CH═CH₂ molecular residue of mono- or polyepoxidized fats or oils in the form of mono-, di-, or triglycerides or molecular residue of mono- or polyepoxized fatty acids or of the C₁-C₂₄ alkyl esters thereof,
R¹ and R² are independently straight-chain or branched C₁-C₈ alkyl, cyclopentyl or cyclohexyl, in particular tert-butyl,
q is 1, 2 or 3, preferably 2 or 3, in particular 2,
n is an integer from 1 to 30, preferably an integer from 1 to 10, advantageously 1, 2, 3, 4, 5 or 6, e.g. 1, 2, 3 or 4, in particular 1,
R³ is an n-valent radical of linear or branched C₁-C₃₀ alkyl or C₂-C₃₀ alkylene, in each case optionally interrupted by one or more oxygen atoms, or (for n=1-12) an n-valent C₅-C₁₂ cycloalkyl radical, or a R₄—[NR⁵—C_{q}H_{2q}-]ₚ radical,
R₄ is hydrogen, an n-valent linear or branched C₁-C₃₀ alkyl radical, optionally interrupted by one or more —NR— groups, or (for n=1-12) an n-valent C₅-C₁₂ cycloalkyl radical,
R⁵ is independently hydrogen or methyl or —C_{q}H_{2q}—, preferably hydrogen, and
p corresponds to the number of —[NR⁵—C_{q}H_{2q}-] groups that has n —C_{q}H_{2q}— radicals per molecule,
k is an integer between 0 and 50, preferably between 10 and 30,
m is an integer between 0 and 50, e.g. 1-40, and
o is an integer between 0 and 50, preferably between 0 and 30, in particular 0,
where (k+m+o) >10
and/or
(v) benzofuranones, diarylamines, triazines, 2,2,6,6-tetramethylpiperidines, hydroxylamines, alkyl and/or aryl phosphites, sulfides, zinc carboxylates or diketones, wherein particularly suitable benzofuranones are described by formula (1e):

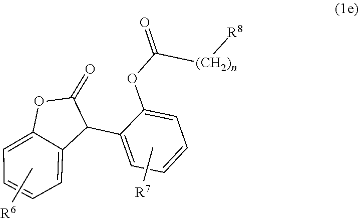

in which
n is an integer between 0 and 7, preferably 0-3,
R⁶ and R⁷ are independently hydrogen or C₁-C₈ alkyl,
R⁶ is hydrogen or an aromatic radical.

The indices used in formulae (1d) and (1e) apply only to this section of the description of the invention. In other sections the same indices may optionally be used for other structures.

Suitable optional flame retardants for the purposes of the present invention are all substances considered suitable for this purpose according to the prior art Examples of preferred optional flame retardants are liquid organophosphorus compounds such as halogen-free organophosphates, for example triethyl phosphate (TEP), halogenated phosphates, e g tris(1-chloro-2-propyl) phosphate (TCPP), tris(1,3-dichloroisopropyl) phosphate (TDCPP) and tris(2-chloroethyl) phosphate (TCEP), and organic phosphonates, for example dimethyl methanephosphonate (DMMP), dimethyl propanephosphonate (DMPP), or oligomeric ethyl-ethylene phosphates or solids such as ammonium polyphosphate (APP) and red phosphorus. Suitable optional flame retardants further include halogenated compounds, for example halogenated polyols, and also solids such as expandable graphite and melamine.

The process of the invention makes it possible to produce polyurethane foams containing particularly high proportions of recycled polyols. The term polyurethane is for the purposes of the present invention to be understood in particular as a generic term for a polymer produced from di- or polyisocyanates and polyols or other isocyanate-reactive species, such as for example amines, wherein the urethane linkage is not necessarily the sole or predominating linkage type. Polyisocyanurates and polyureas are also expressly included.

The production according to the invention of polyurethane foams can be carried out by any processes familiar to those skilled in the art, for example by manual mixing or preferably with the aid of high-pressure or low-pressure foaming machines. The process of the invention may be executed continuously or batchwise. Batchwise execution of the process is preferable in the production of moulded foams, refrigerators, footwear soles or panels. A continuous process is preferable for producing insulation panels, metal composite elements, slabs or in spraying methods.

The invention further provides a polyurethane foam, preferably rigid PU foam, flexible PU foam, hot-cure flexible PU foam (standard foam), viscoelastic PU foam, HR PU foam, hypersoft PU foam, semirigid PU foam, thermoformable PU foam or integral PU foam, preferably hot-cure flexible PU foam, HR PU foam, hypersoft PU foam or viscoelastic PU foam, most preferably hot-cure flexible PU foam, produced by a process of the invention as described hereinabove.

A very particularly preferred flexible polyurethane foam for the purposes of the present invention has in particular the following composition:

| Component | Parts by weight (pphp) |
|---|---|
| Polyol, comprising recycled polyol | 100 |
| (Amine) catalyst | 0.01 to 5 |
| Tin catalyst | 0 to 5, preferably 0.001 to 2 |
| Siloxane | 0.1 to 15, preferably 0.2 to 7 |
| Water | 0 to <15, preferably 0.1 to 10 |
| Further blowing agents | 0 to 130 |
| Flame retardant | 0 to 70 |
| Fillers | 0 to 150 |
| Further additives | 0 to 20 |
| Isocyanate index: | greater than 50 |

The polyurethane foams according to the invention may be used for example as refrigerator insulation, insulation panels, sandwich elements, pipe insulation, spray foam, 1- and 1.5-component can foam (a 1.5-component can foam is a foam that is produced by destroying a container in the can), imitation wood, modelling foam, packaging foam, mattresses, furniture cushioning, automotive seat cushioning, headrests, instrument panels, automotive interior trim, automotive headlining, sound absorption material, steering wheels, shoe soles, carpet backing foam, filter foam, sealing foam, sealants, adhesives, binders, lacquers or as coatings, or for producing corresponding products. This corresponds to a further subject matter of the invention.

1. A process for producing PU foams, comprising:
reacting
(a) at least one polyol component with
(b) at least one isocyanate component,
in the presence of
(c) one or more catalysts that catalyse the isocyanate-polyol and/or isocyanate-water and/or isocyanate trimerization reactions,
(d) at least one foam stabilizer and also
(e) optionally one or more chemical or physical blowing agents,
wherein the at least one polyol component comprises recycled polyol.

2. The process according to claim 1, wherein the PU foam is a rigid PU foam, a flexible PU foam, a hot-cure flexible PU foam, a viscoelastic PU foam, an HR PU foam, a hypersoft PU foam, a semirigid PU foam, a thermoformable PU foam or an integral PU foam.

3. The process according to claim 1, wherein the reaction is carried out using
f) water,
g) one or more organic solvents,
h) one or more stabilizers against oxidative degradation,
i) one or more flame retardants, and/or
j) one or more further additives.

4. The process according to claim 1, wherein the at least one foam stabilizer is selected from the group consisting of silicon compounds that include carbon atoms, a compound as described by the formula (1c) and mixtures of two or more of said compounds:
[R¹₂R²SiO_{1/2}]ₐ[R¹₃SiO_{1/2}]_{b}[R¹₂SiO_{1/2}]_{c}[R¹R²SiO_{2/2}]_{d}[R³SiO_{3/2}]ₑ[SiO_{4/2}]_{f}G_{g} Formula (1c):
with
a=0 to 12,
b=0 to 8,
c=0 to 250,
d=0 to 40,
e=0 to 10,
f=0 to 5,
g=0 to 3,
where:
$$a + b + c + d + e + f + g > 3 , a + b \geq 2 ,$$
G=independently identical or different radicals consisting of
(O_{1/2})ₙSiR¹ₘ—CH₂CHR⁵-R⁴—CHR⁵CH₂—SiR¹ₘ(O_{1/2})ₙ,
(O_{1/2})ₙSiR¹ₘ—CH₂CHR⁵-R₄—CR⁵═CH₂,
(O_{1/2})ₙSiR¹ₘ—CH₂CHR⁵-R⁴—CR₅═CR⁵—CH₃,
R⁴=independently identical or different divalent organic radicals, optionally interrupted by ether, ester or amide groups and optionally functionalized with OH groups, or (—SiR¹₂O—)ₓSiR¹₂ groups,
x=1 to 50, 25,
R⁵=independently identical or different alkyl radicals consisting of 1 to 16 carbon atoms, aryl radicals having 6 to 16 carbon atoms or hydrogen,
where:
$$n = 1 or 2 , m = 1 or 2 , n + m = 3 ,$$
R¹=identical or different radicals selected from the group of saturated or unsaturated alkyl radicals having 1 to 16 carbon atoms or aryl radicals having 6 to 16 carbon atoms or hydrogen or —OR⁶,
R₂=independently identical or different polyethers obtainable by a polymerization of ethylene oxide and/or propylene oxide and/or other alkylene oxides such as butylene oxide or styrene oxide having a general formula (2) or an organic radical corresponding to formula (3)
—(R⁷)ₕ—O—[C₂H₄O]ⱼ—[C₃H₄O]ᵢ—[CR⁸₂CR⁸₂O]ₖ—R⁹, (2)
—Oₕ—R¹⁰, (3)
where
h=0 or 1,
R⁷=divalent organic radical optionally substituted with —OR⁶,
i=0 to 150,
j=0 to 150,
k=0 to 80,
p=1-18,
where
$$i + j + k \geq 3 ,$$
R³=identical or different radicals selected from the group of saturated or unsaturated alkyl radicals potentially substituted with heteroatoms,
R⁶=identical or different radicals selected from the group of saturated or unsaturated alkyl radicals having 1 to 16 carbon atoms or aryl radicals having 6 to 16 carbon atoms or hydrogen,
R⁸=identical or different radicals selected from the group of alkyl radicals having 1 to 18 carbon atoms, potentially substituted with ether functions and potentially substituted with heteroatoms such as halogen atoms, aryl radicals having 6-18 carbon atoms, potentially substituted with ether functions, or hydrogen,
R⁹=identical or different radicals selected from the group hydrogen, alkyl, —C(O)—R¹¹, —C(O)O—R¹¹ or —C(O)NHR¹¹, saturated or unsaturated, optionally substituted with heteroatoms,
R¹⁰=identical or different radicals selected from the group of saturated or unsaturated alkyl radicals or aryl radicals, potentially substituted with one or more OH, ether, epoxide, ester, amine and/or halogen substituents,
R¹¹=identical or different radicals selected from the group of alkyl radicals having 1 to 16 carbon atoms or aryl radicals having 6-16 carbon atoms.

5. The process according to claim 1, wherein the catalyst for production of PU foam is selected from the group consisting of triethylenediamine, 1,4-diazabicyclo[2.2.2]octane-2-methanol, diethanolamine, N-[2-[2-(dimethylamino)ethoxy]ethyl]-N-methyl-1,3-propanediamine, 2-[[2-(2-(dimethylamino)ethoxy)ethyl]methylamino]ethanol, 1,1′-[(3-{bis[3-(dimethylamino)propyl]amino}propyl)imino]dipropan-2-ol, [3-(dimethylamino)propyl]urea, 1,3-bis[3-(dimethylamino)propyl]urea, amine catalysts of general structure (1a) and amine catalysts of general structure (1b): 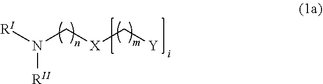
where X comprises oxygen, nitrogen, hydroxyl, amino groups of the structure (NR^{III} or NR^{III}R^{IV}) or urea groups (N(R^{V})C(O)N(R^{VI}) or N(R^{VII})C(O)NR^{VI}R^{VII}),
Y comprises amino groups NR^{VIII}R^{IX} or ethers OR^{IX},
R^{I,II} comprise identical or different, linear or cyclic, aliphatic or aromatic hydrocarbon groups having 1-8 carbon atoms that are optionally functionalized with an OH group and/or comprise hydrogen,
R^{III-IX} comprise identical or different, linear or cyclic, aliphatic or aromatic hydrocarbon groups having 1-8 carbon atoms that are optionally functionalized with an OH group, an NH or NH₂ group and/or comprise hydrogen,
m=0 to 4,
n=2 to 6,
i=0 to 3, 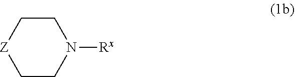
where R^{X} comprises identical or different radicals consisting of hydrogen and/or linear, branched or cyclic, aliphatic or aromatic hydrocarbon groups having 1-18 carbon atoms, which may be substituted with 0-1 hydroxyl groups and 0-1 NH₂ groups,
Z comprises oxygen, N—R^{X} or CH₂,
and/or
metal compounds selected from the group consisting of organometallic metal salts, organic metal salts, inorganic metal salts and organometallic compounds of the metals Sn, Bi, Zn, Al or K, and mixtures of these.

6. The process according to claim 1, wherein the stabilizer against oxidative degradation is selected from the group consisting of
(i) 2-(2′-hydroxyphenyl)benzotriazoles,
(ii) 2-hydroxybenzophenones,
(iii) benzoic acids and benzoates,
(iv) phenols, or methylenediphenols,
and
(v) benzofuranones, diarylamines, triazines, 2,2,6,6-tetramethylpiperidines, hydroxylamines, alkyl and aryl phosphites, sulfides, zinc carboxylates or diketones.

7. The process according to claim 1, wherein a cell opener is used.

8. The process according to claim 1, wherein a hardening promoter from a group of solids that do not dissolve at all or dissolve only very slightly in polyether polyols at room temperature (solubility less than 0.25 g/100 g polyether polyol) is employed, said additive being from the group consisting of sorbitol, trimethylolomelamine, hexamethylolmelamine, glucose, sucrose, erythritol, pentaerythritol, mixtures or hydrates of said compounds and partial esters or ethers thereof.

9. The process according to claim 1, wherein an additive comprising halogen compounds is employed to improve a resistance of the PU foam to hydrolysis.

10. The process according to claim 1, wherein, based on a total employed polyol component, more than 30% by weight of recycled polyol is used.

11. The process according to claim 1, wherein the recycled polyol was obtained from a polyurethane hydrolysis comprising a reaction of polyurethane with water in the presence of a base-catalyst combination (I) or (II),
where (I) comprises a base having a pK_{b} at 25° C. of 1 to 10 and a catalyst selected from the group consisting of quaternary ammonium salts containing an ammonium cation comprising 6 to 30 carbon atoms and organic sulfonates containing at least 7 carbon atoms,
or where (II) comprises a base having a pK_{b} at 25° C. of <1 and a catalyst from the group of quaternary ammonium salts containing an ammonium cation having 6 to 14 carbon atoms in the case of an ammonium cation that does not contain a benzyl substituent and quaternary ammonium salts containing an ammonium cation having 6 to 12 carbon atoms in the case of an ammonium cation that contains a benzyl substituent.

12. A polyurethane foam, wherein it is obtained by the process according to claim 1.

13. A process of manufacturing goods, comprising:
incorporating the polyurethane foam according to claim 12 into refrigerator insulation, insulation panels, sandwich elements, pipe insulation, imitation wood, mattresses, furniture cushioning, automotive seat cushioning, headrests, instrument panels, automotive interior trim, automotive headlining, sound absorption material, steering wheels, shoe soles, carpet backing foam, gad filter foam.

14. The process according to claim 1, wherein the PU foam is a hot-cure flexible PU foam, HR PU foam, hypersoft PU foam or viscoelastic PU foam.

15. The process according to claim 1, wherein the PU foam is a hot-cure flexible PU foam.

16. The process according to claim 1, wherein the reaction is carried out using
f) water,
g) one or more organic solvents,
h) one or more antioxidants,
i) one or more flame retardants, and/or
j) one or more further additives selected from the group consisting of surfactants, biocides, dyes, pigments, fillers, antistatic additives, crosslinkers, chain extenders, cell openers, fragrances, cell expanders, plasticizers, hardening promoters, aldehyde scavengers, buffer substances, additives for resistance of PU foams to hydrolysis, compatibilizers (emulsifiers), adhesion promoters, hydrophobization additives, flame-lamination additives, additives for preventing cold flow, additives that reduce compression set, additives for adjusting the glass transition temperature, temperature-controlling additives and odour-reducers.

17. The process according claim 1, wherein the catalyst for production of PU foam is selected from the group consisting of triethylenediamine, 1,4-diazabicyclo[2.2.2]octane-2-methanol, diethanolamine, N-[2-[2-(dimethylamino)ethoxy]ethyl]-N-methyl-1,3-propanediamine, 2-[[2-(2-(dimethylamino)ethoxy)ethyl]methylamino]ethanol, 1,1′-[(3-{bis[3-(dimethylamino)propyl]amino}propyl)imino]dipropan-2-ol, [3-(dimethylamino)propyl]urea, 1,3-bis[3-(dimethylamino)propyl]urea, amine catalysts of general structure (1a) and amine catalysts of general structure (1b): 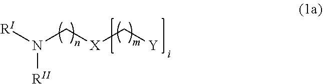
where X comprises oxygen, nitrogen, hydroxyl, amino groups of the structure (NR^{III} or NR^{III}R^{IV}) or urea groups (N(R^{V})C(O)N(R^{VI}) or N(R^{VII})C(O)NR^{VI}R^{VII}),
Y comprises amino groups NR^{VIII}R^{IX} or ethers OR^{IX},
R^{I,II} comprise identical or different, linear or cyclic, aliphatic or aromatic hydrocarbon groups having 1-8 carbon atoms that are optionally functionalized with an OH group and/or comprise hydrogen,
R^{III-IX} comprise identical or different, linear or cyclic, aliphatic or aromatic hydrocarbon groups having 1-8 carbon atoms that are optionally functionalized with an OH group, an NH or NH₂ group and/or comprise hydrogen,
m=0 to 4,
n=2 to 6,
i=0 to 3, 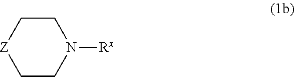
where R^{X} comprises identical or different radicals consisting of hydrogen and/or linear, branched or cyclic, aliphatic or aromatic hydrocarbon groups having 1-18 carbon atoms, which may be substituted with 0-1 hydroxyl groups and 0-1 NH₂ groups,
Z comprises oxygen, N—R^{X}, CH₂, and metal compounds selected from the group consisting of organometallic metal salts, organic metal salts, inorganic metal salts and organometallic compounds of the metals Sn or Bi, and mixtures of these.

18. The process according to claim 1, wherein a cell opener is used from the group of polyether-polysiloxane copolymers, an amount used being from 0.01% to 10% by weight based on a total sum of the polyol components.

19. The process according to claim 1, wherein a cell opener is used from the group of polyether-polysiloxane copolymers, the amount used being from 0.1% to 5% by weight based on the total amount of the polyol components.

20. A process of delivering the polyurethane foam according to claim 12, comprising:
dispensing the PU foam as spray foam, 1-component can foam, 1.5-component can foam, modelling foam, packaging foam, sealing foam, sealants, adhesives, coatings, and for production of corresponding products.
